(19) United States
(12) Patent Application Publication
(10) Pub. No.: US 2010/0092341 A1
(43) Pub. Date: Apr. 15, 2010

(54) BIOCHIP FOR FLUORESCENCE ANALYSIS OF INDIVIDUAL TRANSPORTERS

(76) Inventors: Stefan Hummel, Haseldorf (DE); Matthias Pirsch, Hamburg (DE)

Correspondence Address: COLLARD & ROE, P.C., 1077 NORTHERN BOULEVARD, ROSLYN, NY, 11576, US

(21) Appl. No.: 12/450,093

(22) PCT Filed: Apr. 2, 2008
(86) PCT No.: PCT/DE2008/000532

§ 371 Date: Sep. 10, 2009

(30) Foreign Application Priority Data
Apr. 4, 2007 (DE) 10 2007 016 699.2

(51) Int. Cl. G01N 21/64

(52) U.S. Cl. 422/82.08

(57) ABSTRACT

The invention relates to a biochip (1) for optical measurement of the properties of individual transporter systems (50). In order to measure the properties of transporter molecules (50) with great measurement accuracy and at high throughput, a biochip (1) for optical measurement of the properties of individual transporter systems (50) is proposed, which essentially consists of a transparent carrier (10) and multiple depressions (30) open to the top, whereby the biochip (1) is configured in such a manner that its openings (31) can be covered by a membrane (40), and thus closed measurement chambers (30) are formed, and the transport of substrate molecules (60) into the depressions (30), by way of the membrane (40), can be detected.

The invention relates to a biochip for optical measurement of the properties of individual transporter systems.

Biological membranes separate cells from the external medium and the individual cell compartments from one another. Transporter systems such as transporter proteins and channels selectively control the passage of substances through these membranes. Functional disruptions of these transporters and channels are responsible for numerous wide-spread illnesses. Among the 100 medications most sold in the USA in 2004, membrane transporters were the most frequently occurring target group. At least 1,302 transporter pharmaceuticals, both those that have been introduced and those that are still in development, are contained in the portfolios of 326 companies worldwide. In total, at present more than 100 transporter targets are being researched by the pharmaceutical companies, showing what an immense economic importance they have.

Measurement methods with which properties such as the transport rates of specific substrates through the transporter target and the influence of active substance candidates can be evaluated are required for the development of such active substances. In this connection, in particular, methods are needed that can characterize the individual target molecules even in automated manner, at high throughput.

Electrical measurements can be used for the analysis of transport rates of ions and charged particles. This method is already being used, at high throughput, in biotechnological and pharmaceutical research. However, it is limited to charged transporter substrates and is therefore generally used for the group of the ion channels. The transport of non-charged molecules such as amino acids, peptides, sugar compounds, and fatty acids, but also biological macromolecules such as RNA, DNA, and proteins, can only be measured indirectly when using electrical methods.

Fluorescence analysis, in contrast, can make the transporter of these molecules visible. First preliminary work in this regard was carried out by an academic group for the transport of biomolecules through the nuclear pore complex in nucleus sheaths of Xenopus Laevis. It was also used for measuring the transport of calcium ions through the α-hemolysin pore, which was directly inserted into pre-finished, artificial lipid membranes, and in this connection folds back from a denatured structure into a functional shape.

In the publications, for this purpose polycarbonate filters or polycarbonate structures were used, the depressions of which were utilized for the fluorescence measurement of transport rates by means of confocal laser scanning microscopy. This involves poor optical properties, among other things due to divergences in the indices of refraction of polycarbonate and measurement buffer. Further experiments that lead beyond basic research to a biotechnological or pharmaceutical application of the method at high throughput have not been published.

It is therefore the task of the invention to propose a device by means of which the properties of transporter molecules can be measured at great measurement accuracy and high throughput.

This task is accomplished in that a biochip for optical measurement of the properties of individual transporter systems is proposed, which essentially consists of a transparent carrier and multiple depressions that are open to the top, whereby the biochip is configured in such a manner that its openings can be covered by a membrane, and thus closed measurement chambers are formed and the transport of substrate molecules into the depressions, by way of the membranes, can be detected. For this purpose, the membrane is stretched over the depressions in the biochip, so that they are closed. Transporter substrates added above the membrane, which can be detected by means of fluorescence methods, therefore get into the measurement chambers of the biochip only by means of the transporter proteins or channels contained in the membrane. By means of fluorescence measurements, these substrates can be detected in the depressions and quantified. An evaluation yields parameters such as the transport rate, which allow conclusions concerning the transporter protein/the channel or an influence of the active substance candidate, for example. Both the method and the evaluation can be automated and used at high throughput.

If a conductive layer, preferably made of metal, is applied to the biochip, it can additionally be used as an electrode, preferably for measurement of impedance spectroscopy or also for applying an electrical field. With a second electrode in the solution above the membrane, information concerning the electrical density of an applied lipid layer or a cell layer can be provided. This can be used as quality control for the quality of the lipid layer or also for an assessment of the viability of the cells. An applied electrical field can be used to control voltage-dependent channel proteins, for example in order to switch an ion channel to the open state and then to carry out a transporter measurement by means of fluorescence measurement of an ion-dependent fluorescence indicator, as described.

For the biotechnological and pharmaceutical use of this method, it is necessary to use proteoliposomes, in other words artificial, hollow membrane vesicles that contain transporter proteins inserted into the membrane. These can either be coupled directly with the activated surface of the biochip, or applied by means of fusion with a pre-shaped lipid membrane. In this connection, the vesicle is re-shaped into a membrane that contains the transporter, which membrane closes off the measurement chambers in the biochip formed from the depressions, and thus allows a fluorescence measurement for characterization of the transporters and a determination of the transport rates.

It is advantageous if the carrier consists of a material having a high index of refraction, such as glass, silicon, or silicon dioxide. In this way, optical artifacts are reduced, and fluorescence detection in the depressions, which have dimensions in the nanometer range, is made possible. If the index of refraction is higher than the index of refraction of the measurement solution used, a total reflection and thus an evanescent field at the phase border of material and measurement solution can be produced by radiating the excitation light in at an angle, and utilized for the fluorescence detection.

The carrier (10) can have one or more layers (20) connected with its top. The depressions (30), which are open to the top, are provided in the layer or layers (20). In this way, different material can be used for the carrier and the measurement chambers, and this allows other advantageous properties.

In a preferred embodiment, the diameter of the depressions is smaller than the wavelength of the excitation light, so that the depressions are configured as zero-mode wave guides. The intensity of the excitation light then decreases exponentially within the measurement chamber, thereby making highly selective excitation possible.

If at least one of the layers consists of light-impermeable material, particularly metal, the biochip is essentially light-impermeable at its top. In this way, the excitation light is shielded away from the membrane. Fluorescent substrate molecules that are situated in the membrane or above the membrane, in other words outside of the measurement chamber, therefore cannot be excited. In this way, a disruptive background signal is reduced or avoided.

A particularly suitable metal is gold, since it is chemically inert, can be reliably connected with the carrier material, and furthermore has suitable light reflection properties. Titanium is also suitable.

The metal layer is firmly connected with the carrier by means of an adhesion mediator. It has turned out that a metal, particularly chrome or titanium, is very well suited as an adhesion mediator.

An improvement in the measurement accuracy can be achieved in that the metal layer is configured to be reflective on its underside, in order to reflect the excitation light and thus to excite the substrate molecules multiple times.

The opening of the depression can be partly covered by the metal layer disposed above it, in that the opening of the metal layer is selected in such a manner that it is smaller than the depression opening. In this way, the excitation light is shielded away even more from the substrate molecules that are not situated in the measurement chamber, and thus the measurement accuracy is improved.

In addition, the metal layer that lies above the openings can be used as an electrode for electrical measurements of the membrane, or also can be used for generating an electrical field.

If the layer consists of silicon dioxide, fluorescence detection of the transporter substrates in the depressions of the layer is possible.

If the layer that lies on the transparent carrier consists of a fluoropolymer, such as Teflon or Cytop, then this allows the detection of fluorescence in the measurement chambers, for example by means of confocal laser scanning microscopy.

A further improvement can be achieved in that the diameter of the depressions continuously decreases from the bottom toward the top, so that the depressions have an approximately conical shape. The diameters of the chambers that are larger toward the carrier then allow detection of the fluorescence in the measurement chambers formed in this manner, at great accuracy.

The coupling, in other words the fixation of the biological membranes or artificial vesicles on the biochip, can take place in such a manner that its surface has linker molecules that are particularly amino-reactive and/or lipid derivatives, which bind to suitable components of the membrane, in covalent or non-covalent manner.

The membrane has one or more proteins, particularly pore, channel, or carrier proteins, as transporter molecules; their transport activity is detected by way of the vesicle membrane.

Another use of the biochip is the characterization of production cell lines for recombinant proteins and antibodies. For this purpose, cells or cell components for the production of recombinant proteins or antibodies are measured. In this connection, the cells are bound to the biochip, so that they close off the depressions of the chip with their membrane. It is also possible to allow cells to grow on the biochips. When the proteins produced are secreted into the measurement chambers, a fluorescence signal is generated by way of a reporter system. This fluorescence signal provides information about the amount of recombinant proteins or antibodies produced, and thus allows finding cells that have high production, which can be used for the biotechnological production of these proteins and antibodies.

The membranes used in the measurement can be biological or artificial lipid membranes. If biological membranes are used, particularly natural measurement conditions are obtained.

Preferably, the measurement takes place with a vesicle membrane that contains transporter molecules reconstituted in it. This allows fast, reproducible measurements. Furthermore, the transporter protein takes its functional conformation on again as the result of embedding in the vesicle membrane.

A precise measurement is possible if the membrane stretched over a depression contains only a few, preferably one to three transporter molecules.

Detection of the substrate transported by the transporter molecules is made possible in that the substrate molecules fluoresce, preferably in that they are bound to a fluorescence dye, but also by means of binding to a substrate-dependent fluorescence indicator, for example for measuring ion flows.

The fluorescent substrate molecules are transported into the depressions of the biochip by the transporter molecule, by way of the membrane. There, they are detected by means of a suitable fluorescence detection device.

A particularly accurate measurement takes place in that the detection device measures the fluorescence in a confocal plane within the depression.

Another improvement in accuracy is achieved in that the diameter of the depressions is selected in such a manner, taking the wavelength of the excitation light into consideration, that an evanescent field is generated, which is used for fluorescence detection.

In another embodiment, an evanescent field is generated in that the excitation light is radiated in at a totally reflective angle, and thus used for fluorescence detection.

In another preferred embodiment, a layer is configured to be electrically charged and as an electrode, in order to thereby measure the membrane electrically or excite it. A suitable layer can be, for example, the metal layer made of gold that is disposed above the carrier.

Surprisingly, the layer can thereby additionally be used as an electrode for characterization of the electrical properties of membranes, cell layers, or of the transporter systems found in the membrane.

In this connection, the biochip can be used in such a manner that the impedance of the membrane or epithelial layer stretched over the biochip is measured with transporter systems, for example transporter proteins. In this way, the density of the membrane can be determined.

However, the biochip can additionally be used also to generate an electrical field, by means of the electrode, particularly in order to control voltage-sensitive transporter systems. These are, for example, voltage-dependent ion channels, i.e. ion channels that open or close at a certain limit value of the membrane voltage. By means of changing the applied electrical field, functional switching processes can be triggered in this way, which result in a change in the transport of substrate by way of the membrane. The transporter substrate can then be detected in the depressions, by means of fluorescence indicators.

An exemplary use of the biochip consists in having the upper metal layer of the biochip be covered with a lipid membrane that contains ion channels. For a measurement, an electrical field is applied to the electrically conductive layer, in other words the electrode. The voltage applied leads to activation of the ion channels. In this way, an ion stream into the depressions is formed, by way of the membrane, and this stream is then quantitatively detected by means of fluorescence.

The proposed biochip therefore surprisingly has the additional advantage that it can switch biological transporter systems to be electrically functional, and, at the same time, can measure the transport by way of the membrane that results from this, optically, by means of fluorescence.

The invention will be described as an example, in a preferred embodiment, making reference to a drawing, whereby other advantageous details can be derived from the figures of the drawing.

In this connection, parts that have the same function are provided with the same reference symbol.

The figures of the drawing show, in detail:

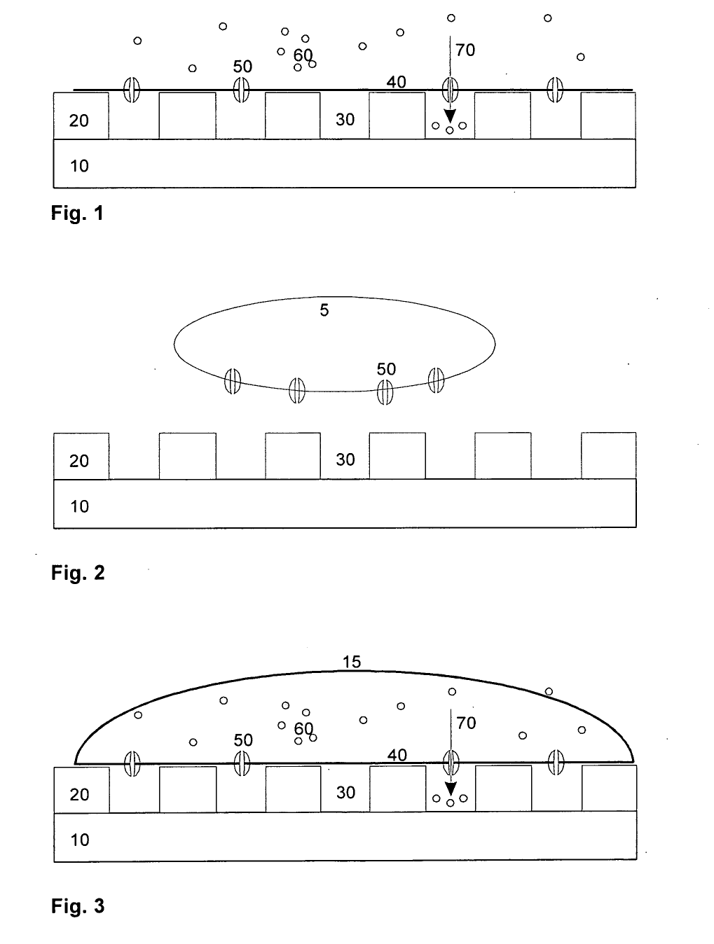

FIG. 1 a vertical section of the biochip according to the invention;

FIG. 2 a vertical section as in FIG. 1, with a vesicle;

FIG. 3 a vertical section as in FIG. 2, with a biological cell lying on top;

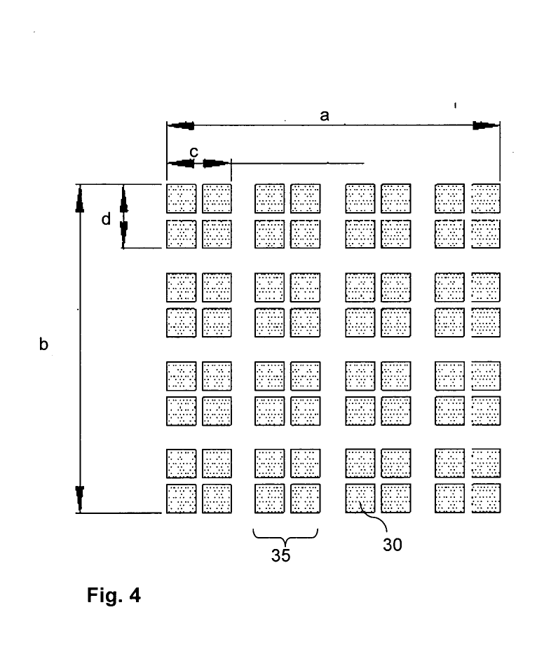

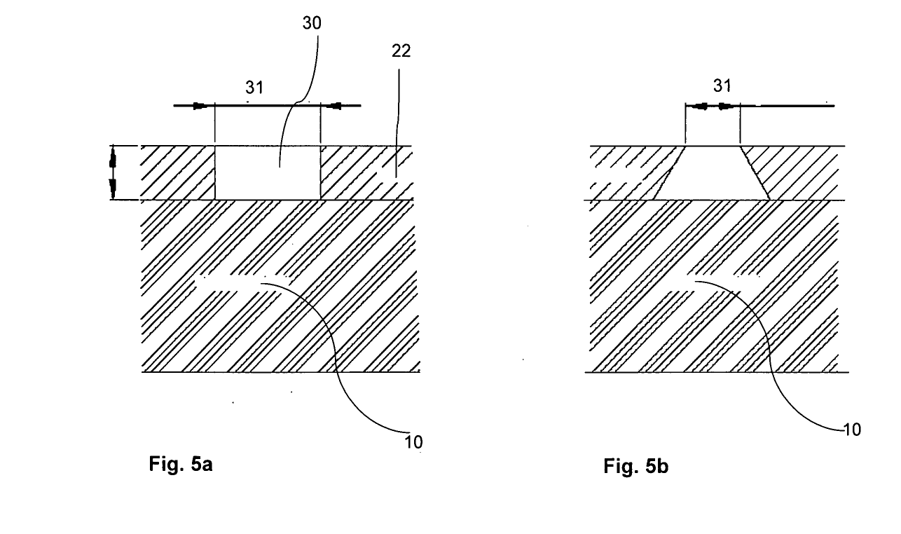

FIG. 4 a top view of an array of the biochip;

FIG. 5a a detail view of the biochip, with a depression, in vertical section;

FIG. 5b a detail view of the biochip, with a cone-shaped depression of the biochip, in vertical section and

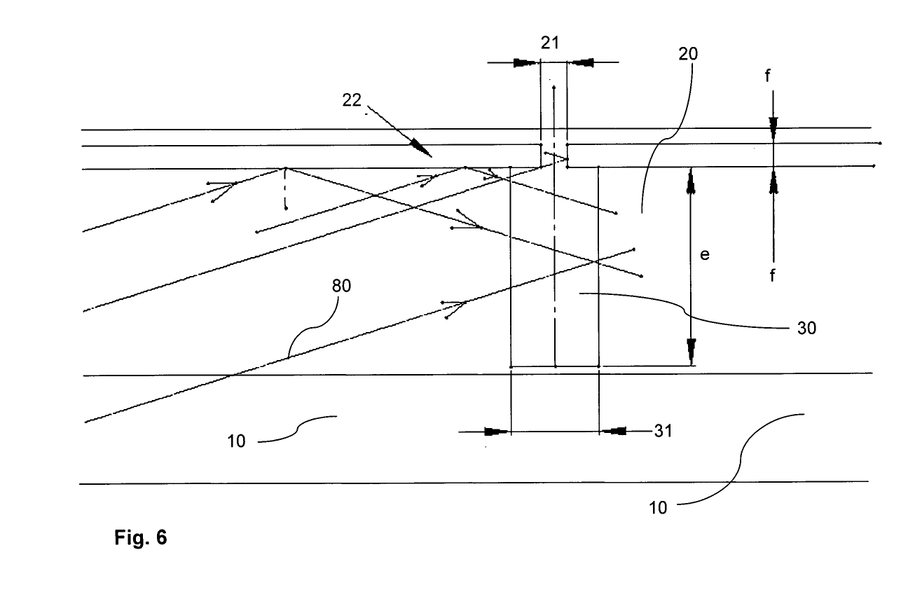

FIG. 6 a detail view of a preferred embodiment of the biochip, with a depression, in vertical section.

FIG. 1 shows a vertical section through the biochip according to the invention.

The biochip 1 consists of a carrier 10 that is transparent for the excitation light or fluorescence light. At its top, the chip has depressions 30 that serve as measurement chambers for detecting a substrate 60. In the embodiment shown, the biochip 1 consists of a composite of different materials. The basis is formed by the optically permeable carrier 10 made of cover glass. A layer of silicon dioxide 20 is disposed on the top of the carrier. A layer of titanium is applied on top of the silicon dioxide layer 20, and serves both as a reflector for the excitation light 80 and as an adhesion mediator for another layer made of gold. The gold layer can be contacted and used as an electrode. The three layers 20 contain continuous depressions 30, by means of which one measurement chamber open to the top, in each instance, is formed.

For measurement, a membrane 40 is applied to the surface of the biochip 1, so that the measurement chambers 30 are closed off. The membrane 40 can be produced from artificial proteoliposomes 5, which contain transporter proteins or pore proteins as a transporter system. On the other hand, the membrane 40 can also be the cell membrane of production cell lines for recombinant proteins or antibodies.

The membrane 40 contains transporter systems 50, such as transporter proteins or pore proteins. As an example, transporters of the ABC transporter group can be named in this connection, which are relevant for many diseases, such as the adrenoleukodystrophy ABCD1 transporter with fatty acids as a substrate, for example, or the glutamate transporter with the substrate glutamate, for example, whose metabolism is disrupted in the case of psychological illnesses.

Above the membrane, one or more transporter substrates 60 that can be detected with fluorescence methods are added. This is made possible, for example, in that the substrate is covalently marked with a fluorescence dye. The transport 70 of the transporter substrates into the depressions 30 of the biochip, by means of the transporter systems 50 contained in the membrane 40, is specific for the transporter system 50 contained in it, and can be quantified by means of fluorescence measurements in the measurement chambers 30. This allows conclusions concerning parameters specific for the transporter system 50, such as transport rates and permeability, and thus an evaluation of active substance candidates or the production rates of production cell lines.

The biochip can consist of a fluoropolymer 20 such as Teflon or Cytop, which contains the measurement chambers 30 and is applied to a light-permeable carrier 10. This allows detection of the fluorescence in the measurement chambers, for example by means of confocal laser scanning microscopy.

However, the biochip can also consist of a metal layer 20 in which holes 30 are made, and which are applied to a light-permeable carrier 10. If the diameter of the holes 30 goes below a certain size in the nanometer range, then the light being radiated in can no longer penetrate completely into the measurement chambers, and instead, an evanescent field forms at the transition from the carrier to the measurement chamber filled with measurement solution. The depressions then represent “zero-mode wave guides” and thus allow detection of the fluorescence in the measurement chambers formed.

Another possibility for producing the biochip consists in etching conical holes 30 into silicon dioxide 20, in anisotropic manner, and then applying this to a permeable carrier 10. The diameter of the holes, which is larger toward the carrier 10, then allows detection of the fluorescence in these depressions.

Furthermore, the biochip can be produced by generating depressions 30 in a material having a high index of refraction, such as glass 10+20, for example, index of refraction 1.53. This index of refraction is clearly greater than that of the measurement solution situated in the measurement chambers 30, having an index of refraction of 1.33. If the excitation light is radiated in at a slant from below, then an evanescent field is produced starting from a certain angle, at the transition from the carrier to the measurement solution, in the case of total reflection of the light, which field can be used to detect the fluorescence in the measurement chambers 30.

FIG. 2 shows a vertical section as in FIG. 1, with a vesicle (5). Pore-forming proteins (50) are reconstituted in the vesicle membrane.

FIG. 3 shows a vertical section as in FIG. 2, with a biological cell 15 lying on top. This can be complete cell 15 or also only part of it. The cell extends over multiple depressions 30 and covers them. In this way, a measurement under natural biological conditions is possible.

FIG. 4 shows a top view of an array 36 of the biochip 1. This is formed in that four depressions 30, which are square in the top view, in each instance, are disposed close to one another, and thus form a group 35. In this connection, the group 35 has a length c and a width d of about 100 μm, in each instance. Sixteen depression groups 35, i.e. sixty-four depressions 30, in each instance, are disposed to form an array 36, which has a length a and a width b of about 500 μm, in each instance.

FIG. 5a shows a detail view of an embodiment of the biochip 1 with a depression 30, in vertical section. In this connection, a metal layer made of gold is applied to a carrier 10 made of cover glass, by means of an adhesion mediator made of chrome or titanium (not shown). In this embodiment, the measurement chamber 30 is therefore exclusively formed by the opening 31 in the metal, while the glass carrier 10 itself does not have any depression.

FIG. 5b shows a similar embodiment as in FIG. 5a, but the metal layer 20 has a conical, i.e. cone-shaped depression 30. The opening 31 also has a diameter of 60 to 120 nm at its top, but widens toward the bottom. In this way, the measurement accuracy is increased, because the measurement chamber 30 contains more substrate 60 (not shown) and thus the signal/noise ratio is improved.

FIG. 6 shows a detail view of a preferred embodiment of the biochip 1 with a depression 30 in vertical section. In this connection, another metal layer made of gold is applied to a carrier 10 made of cover glass and a layer of silicon dioxide 20 connected with it, by means of an adhesion mediator made of chrome or titanium (not shown). The two metal layers together have a thickness of about 100 nm. The silicon dioxide and metal layers are provided with a layer opening 31 and a continuous depression 30, which has a diameter of 200 nm. The pitch is 500 nm. For measuring cellular membranes, the pitch is 1 to 2.5 μm.

In contrast to the embodiments shown above, the measurement chamber is formed by the depression 30 within the layer composed of silicon dioxide 20 and the two metal layers. In this connection, the depression has a length e of about 1 μm, and an opening diameter 31 of about 200 nm. The thickness f of the metal layer preferably amounts to about 100 nm; the diameter of the layer opening 21 is about 200 nm.

An advantage of this embodiment consists in, for one thing, that the measurement chamber formed in the glass carrier 10 by means of the depression 30 has a greater expanse in the vertical direction. In this way, the substrate molecules 50 (not shown) transported by way of the membrane are farther removed from the membrane, on the average, and thus from the non-transported substrate molecules 50. Ideally, only the substrate molecules 50 situated below the lipid membrane (not shown) should be excited to fluoresce, and this is facilitated by the greater spatial distance. In this way, the signal/noise ratio is increased.

The signal/noise ratio can further be improved in that the upper depression opening 31 is partly covered by the metal layer 20. In this way, the excitation light is effectively shielded away from the non-transported substrate molecules 50 (not shown) above the membrane.

Another and surprising advantage consists in that the metal layer 20 reflects the excitation light. In order to make this clear, FIG. 6 shows a schematic representation of the beams 80 of the excitation light. A parallel light bundle 80 is radiated into the underside of the glass carrier 10 at a slanted angle. In this connection, the beam path is disposed as in the case of a commercially available TIRF microscope. The beams 80 are reflected by the metal layer 20 and pass through the measurement volume 30 containing the sample 60 (not shown) multiple times.

In this way, the signal excitation is amplified multiple times, and this significantly improves the measurement accuracy even further.

The evanescent wave that forms next to the excitation light is not shown in FIG. 6. Because of the slanted incidence and the thickness of the metal layer 20, the diameter is not sufficient for “zero-mode” excitation, but this is desirable for signal suppression.

### REFERENCE SYMBOL LIST

1 biochip
5 vesicle
10 carrier
15 biological cell
20 layer
21 layer opening
30 depression
31 depression opening
35 depression group
36 array
40 membrane
50 transporter molecule
60 substrate
80 excitation light

1-10. (canceled)

11. Biochip (1) for optical measurement of the properties of membrane-bound active or passive transporter systems (50), which has a layer (20) having multiple depressions (30) configured as measurement chambers, wherein an essentially light-impermeable layer (22) having openings (21) for the measurement chambers (30) is disposed on the layer (20), in order to shield excitation light (80) away from the membrane and substrate molecules (60) outside of the measurement chambers (30) when measuring the transport (70) of substrate molecules (60) into the closed measurement chambers (30), by way of a lipid membrane (40).

12. Biochip (1) according to claim 11, wherein the layer (20) having the measurement chambers (30) is transparent and preferably consists of a material having an index of refraction greater than 1.33.

13. Biochip (1) according to claim 11, wherein the layer (20) having the measurement chambers (30) consists of glass, silicon, silicon dioxide, or a fluoropolymer.

14. Biochip (1) according to claim 11, wherein a transparent carrier (10) is provided for the layer (20) having the measurement chambers (30), which carrier preferably consists of glass or silicon or silicon dioxide.

15. Biochip (1) according to claim 11, wherein the essentially light-impermeable layer (22) consists of metal, preferably of gold, titanium, or chrome, and is configured to be reflective, in order to reflect excitation light (80) into the measurement chambers (30).

16. Biochip (1) according to claim 11, wherein the openings (21) in the essentially light-impermeable layer (22) are smaller than the openings (31) of the measurement chambers (30), in order to shield excitation light (80) away from substrate molecules (60) outside of the measurement chambers (30).

17. Biochip (1) according to claim 11, wherein an artificial or natural lipid membrane (40) is disposed on the light-impermeable layer (22), which spans and closes one or more openings (21) of the measurement chambers (30).

18. Biochip (1) according to claim 11, wherein linker molecules, which are particularly amino-reactive, and/or lipid derivatives, are provided for binding the lipid membrane (40) to the chip (1).

19. Biochip (1) according to claim 11, wherein the metal layer (22) is configured as an electrode, and another electrode is provided above the lipid membrane (40), in order to measure an impedance or a current flow through the lipid membrane (40) and/or its transporter systems (50), or to switch the transporter systems (50) by means of applying an electrical potential.
